(19) United States
(12) Patent Application Publication
(10) Pub. No.: US 2020/0069124 A1
(43) Pub. Date: Mar. 5, 2020

(54) Ergonomic, Dust Extraction Extender Tool For Attachment And Use With Power Tools

(71) Applicant: Ryan Chesser, Jacksonville, FL (US)

(72) Inventor: Ryan Chesser, Jacksonville, FL (US)

(21) Appl. No.: 16/554,022

(22) Filed: Aug. 28, 2019

Related U.S. Application Data
(60) Provisional application No. 62/723,822, filed on Aug. 28, 2018.

(51) Int. Cl. A47L 7/00; F16M 13/02

(52) U.S. Cl. CPC A47L 7/0095; F16M 13/02

(57) ABSTRACT

The present invention provides for an ergonomic dust extraction extender tool to assist in ergonomically operating hand-held power tools while acting on an object or surface and furthermore allows for the collection of harmful dust being generated while a hand-held power tool is in use. Exemplary embodiments include a tool mounting assembly at the distal end of the tool, a handle at the proximate end of the tool, and an intermediate extent connected between the mounting assembly and the handle. Other aspects include the use of mounting assemblies for securing power tools to the extender tool, the handle at the proximate end of the tool being angularly offset from the connection portion, the incorporation of a dust collection mechanism at or about the mounting assembly, and a dust monitoring sensor for monitoring dust content and limits of certain dust content.

### CROSS-REFERENCE TO RELATED APPLICATIONS

This application claims the benefit of U.S. Provisional Application No. 62/723,822, having a filing date of Aug. 28, 2018, the disclosure of which is hereby incorporated by reference in its entirety and all commonly owned.

### FIELD OF THE INVENTION

The present invention relates to devices for ergonomically operating hand-held power tools and extracting dust from working surfaces, and more particularly, to a device for lessening the musculoskeletal stresses associated with the manually lifting, or repetitively moving of hand-held power tools, and extracting dust, and small particles away from the working surface in the construction or deconstruction or rehabilitation of structures, and foundations, and walkways.

### BACKGROUND OF THE INVENTION

Performing manual labor in awkward positions, e.g. hunched over, on one's knees or on one knee supported by a limb, can lead to repetitive motion and musculoskeletal injuries. Repetitive motion injuries are the most common form of injuries. Said injuries are the result of microscopic tears in the tissue and inflammation. Often times tears and inflammation occur when one tries to move one's body or joints in ways that they were not designed to move, in other words, un-ergonomically. Mounting a hand tool on a frame that allows an operator to position themselves ergonomically greatly lessens the chance of repetitive motion and musculoskeletal injury.

Positioning one's self ergonomically allows operators to dramatically increase the force they can impart on said tool, which in turn increases the force of the tool on the material or structure being worked on. Increasing the force imparted on said tool increases the amount of work accomplished within a given timeframe. It also increases the speed and efficiency of the work performed by allowing the operator to angle the tool in relation to the surface of the material being operated on and walk behind the tool, without having to stop or reposition, as s/he operates over a large area.

By design hand-held power tools cut, chip, drill, plane, demolish or otherwise act on a material or structure. In the process said tools atomize particles of the material or material being worked on. Working in close proximity to the bit, blade or chisel of hand-held power tool exposes the operator to significant risk. Prolonged exposure to airborne particles and debris can lead to serious health complications or even death. According to OSHA, the fourth common work related injuries are respiratory. Exposure increases exponentially with distance. Allowing an operator to stand five to six feet from the end of the power tool greatly reduces exposure and risk of respiratory injury.

The prior art consists of stationary jigs, lifting and holding devices, adapter handles, trolleys and self-propelled vehicles. The primary benefit of these devices is to reduce workload of the operator by either bearing the weight of the tool as well in dissipating vibrations associated with operations or by means of a mechanized vehicle that the operator rides on or walks behind. The former inventions perform their functions by supporting the tool in a relatively stationary position and by supplanting the force of the operator with hydraulic or mechanical means. The later are specialized vehicles designed to perform a single operation.

Stationary jigs, lifting and holding devices, and adapter handles are useful in performing work on a single object or structure for a prolonged period of time. For example, a self-supporting jig is useful in demolishing a wall, foundation or rock ledge where it is necessary to chisel in one spot for a relatively long period of time. It is not effective in situations where hand-held power tools are typically deployed. In situations where a hand-held power tool is appropriate, the operator is expected to move about as they work, or space considerations prevent use of a jig or device. An adapter handle does not improve the ergonomic positioning relative to the tool and the operator, improve performance, or reduce strains and extract dust.

Self-propelled units are large, heavy and costly making them inappropriate for the vast majority of applications. A self-propelled machine is expensive to purchase, costly to maintain, requires training, is difficult to get into and out of many locations and requires relatively long, straight runs to be cost-effective. Self-propelled units are inherently dangerous in that improper operations can result in significant injury to person and property or death.

Hand-held power tools are not designed with effective means of dust collection. Shrouds and covers are bulky and clog easily making them ineffective. Effective dust collection can be accomplished by positioning the hose of a shop vac near the tip of the power tool.

Manually lifting hand-held power tools and dust creation is a common occurrence both in a controlled environment like a workshop and in an uncontrolled environment like a commercial construction site or residential remodeling project. In many cases, it is difficult to deploy jigs or mounts because of limitations such as terrain, surroundings, or the need to continually reposition tools during the course of work. Operating hand-held power tools in an other-than-ergonomic manner may result in musculoskeletal disorders, along with inefficient use of the hand-held power tool. It is appreciated that from many sitting or kneeling positions that efficient angles of torque are not being applied to the tool, thus prolonging the operator being in an uncomfortable position. Thus there remains an immediate need for a device to assist in ergonomically operating the tool while acting on an object or surface.

Furthermore, for many of these handheld tools, the operator is forced to hold the tool at or near the same location as dust may collect while using the power tool. Having to manually remove dust and particles from the working area causes additional time inefficiencies. Moreover, operating hand-held power tools in a dusty domain further causes the operator to inhale dust and particles or other particulate, even that which is known to be or potentially harmful. Thus there remains an unmet need that allows for the collection of harmful dust being generated while a power tool is in use.

### SUMMARY OF THE INVENTION

The present invention provides for an ergonomic dust extraction extender tool to assist in ergonomically operating hand-held power tools while acting on an object or surface and furthermore allows for the collection of harmful dust being generated while a hand-held power tool is in use.

At least one aspect of the ergonomic dust extraction extender tool, the tool has two ends, a proximate end and a distal end, for use with the operation of power tools. The tool includes a tool mounting assembly at the distal end of said tool, a handle at the proximate end of said tool, and an intermediate extent connected between the mounting assembly and the handle.

Yet at least one other aspect of the ergonomic dust extraction extender tool, the tool mounting assembly at the distal end of tool contains at least one fastening means to secure a hand-held power tool to the mounting assembly.

In at least one other aspect of the ergonomic dust extraction extender tool, the handle at the proximate end of the tool includes at least one hand holding portion and at least one connection portion, and is angularly offset from the connection portion, where the connection portion is perpendicularly connected to the upper portion of the intermediate extent.

In at least one other aspect of the ergonomic dust extraction extender tool, the intermediate extent connected between the mounting assembly and the handle of the intermediate extent includes a lower portion and an upper portion, where the lower portion and upper portion are connected with at least one angular offset forming a bend between the upper portion and the lower portion, whereby allowing the handle and the mounting assembly to be at different angles with respect to an operating surface.

In at least one other aspect of the ergonomic dust extraction extender tool, a dust collection mechanism is attached at or about the mounting assembly for enabling the collection of dust at said power tools point of use, wherein the dust collection mechanism has two ends, a first end and a second end, the first end proximate to the distal end of the tool, and the second end proximate to the intermediate extent, wherein the first end and the second end are connected forming a hollow tube, and further having a connection means for a vacuum hose.

In at least one other aspect of the ergonomic dust extraction extender tool, a dust monitoring sensor with optional sensor or alarm is included for monitoring dust content and limits of certain dust content as dust is generated by operation of the power tools with the inventive tool.

### BRIEF DESCRIPTION OF THE DRAWINGS

FIG. 1 provides an overhead view of one embodiment of the inventive tool which includes 110 the hand-held power tool mounting assembly, 120 the ergonomic frame and 130 the ergonomic handle and control mechanism.

FIG. 2A illustrates a blown up view of one embodiment of the 110 hand-held power tool mounting assembly. The 110 assembly includes a 111 fastening means to secure the handle of the hand-held power tool to the shaft of the inventive tool which prohibits movement along the Y axis and provides stabilization, 112 a fastening means for securing the hand-held power tool along the Z axis and holding it securely to 111, 113 a series of fastening means for securing the body of the hand-held power tool and prohibiting movement along the X Axis, 114 a fastening means for securing the nose of the hand-held power tool in the area above the Chuck to the mounting assembly.

FIG. 2B illustrates one embodiment of the dust collection mechanism. The dust collection mechanism consists of 115 a mechanism for positioning and securing a flexible vacuum hose proximate to the tip, or bit, or blade of the hand-held power tool, 117 a mechanism for securing the dust collection mechanism to either the hand-held power tool or 111 the inventive tool mounting assembly, and 116 a positioning mechanism that connects 115 the flexible vacuum hose positioning mechanism to 117 the securing mechanism and sets the angle of incidence between the flexible vacuum hose and the hand-held power tool tip, or bit, or blade. In another embodiment 116 the positioning mechanism may pivot allowing the operator to manually adjust the angle of incidence.

FIG. 3 provides an overhead view of one embodiment of the 120 the ergonomic frame, illustrating the 121 lower frame assembly which is offset from the 122 upper frame assembly allowing the operator to set the angel of incidence of the hand-held power tool with the surface being operated on that achieves maximum performance. In another embodiment of the 121 lower frame assembly, the shaft may be telescoping allowing operators to increase or decrease the length of the shaft. Offsetting the 121 lower frame assembly and the 122 upper frame assembly allows the operator to stand in an upright or prone position during operation, reducing the strain on the musculoskeletal system. In another embodiment the upper and lower shaft will be configured in a sinusoidal curve.

FIG. 4 illustrates at least one embodiment of the 121 lower frame assembly may also include 123 operating wheels or a track ball attached to the back that will bear the weight of the unit and allow it to stand upright when not in use.

FIG. 5 provides an overhead view of one embodiment of the 130 the ergonomic handle bar mechanism, illustrating the ergonomic offset of the 131 right hand grip and the 132 left hand grip from the 133 main handlebar shaft.

FIG. 6 illustrates at least one embodiment of the handle bar mechanism may include 134 non-conductive triggers on the hand grips that will allow the operator to start and stop the hand-held power tool from the handle bars.

FIG. 7 Another embodiment of the 121 lower frame assembly may include 124 a step pad allowing the operator to use his legs and body weight to forcibly propel the hand-held power tool into the surface being operated on.

### DETAILED DESCRIPTION OF THE INVENTION

The present invention provides for a device to assist in ergonomically operating the tool while acting on an object or surface. The present invention further provides for the collection of harmful dust being generated while a power tool is in use. In addition, the present invention provides a safe distance from the point of operation, adding protection for the users face & body from flying debris or power tool malfunction, creating safer means of tool operation.

The following detailed description is merely exemplary in nature and is in no way intended to limit the scope of the invention, its application, or uses, which may vary. The invention is described with relation to the non-limiting definitions and terminology included herein. These definitions and terminology are not designed to function as a limitation on the scope or practice of the invention, but are presented for illustrative and descriptive purposes only.

Various terms used throughout the specification and claims are defined as set forth below as it may be helpful to an understanding of the invention.

As used herein, “ergonomic” shall mean relating to or designed for efficiency and comfort in the working environment. By way of example, and not limited to the particular suggestions, an ergonomic chair increases one's comfort while seated and reduces stress on the musculoskeletal system.

As used herein, “shop vac” shall mean an appliance relating to or designed for removing dust or liquid from a material or surface. By way of example, and not limited to the particular suggestions, they vacuumed up the dust with the shop vac.

The present invention contains the features of an ergonomic, dust extraction extender tool for attachment and use with power tools as herein described.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

### General

The present invention provides for an ergonomic dust extraction extender tool having two ends, a proximate end and a distal end, for use with the operation of power tools. The ergonomic further includes a tool mounting assembly at the distal end of said tool, a handle at the proximate end of said tool, and an intermediate extent connected between said mounting assembly and said handle. Embodiments of the present invention are intended to attach to third party hand-held power tools to capture dust and particles while allowing the operator to work in an ergonomic position that lessens musculoskeletal stresses, the dispersion of dust and particles and associated injuries.

Embodiments of the present invention allow power tool operators to position themselves ergonomically while using a hand-held power tool. In addition some embodiments provide a universal way to secure a hand tool to a shaft and control the tool's operation from a distance of several feet from the point of operation. Without being bound to a particular theory, embodiments including these features are believed to i) allow the operator to lessen stress on their musculoskeletal system; ii) allow the operator to better leverage their mass and strength to aid in the hand-held power tool's operation; ii) lessen the operator's exposure to dust or particles generated from the operation of the power tool; and iv) assist in collecting dirt and debris before they become airborne hazards.

To provide ergonomic benefits, and assist in operator comfort, some embodiments are intended to reduce or limit the weight of the tool. In some embodiments, the tool weighs up to twenty five pounds. Yet in other embodiments, the tool weighs between five to ten pounds. It is appreciated that material selection largely affects the overall weight of the tool, however nothing herein is intended to limit the selection of the materials used for the construction of the tool.

### Hand-Held Power Tool Mounting Assembly

The tool mounting assembly is intended to provide a means of securely holding a hand-held power tool to the ergonomic frame. In at least one embodiment, the tool mounting assembly consists of a backing and fasteners. Where used, the backing may consist of a bar, flat plate, frame, honeycomb, combinations thereof, or other structures capable of fastening the hand tool to the ergonomic frame and immobilizing it during operation. While it is appreciated that any selection of material may be used, certain embodiments of the backing are constructed from steel, aluminum, polymers, carbon fiber, combinations thereof or other materials.

Some embodiments include one or more fastening means. It is intended that such fastening means is intended to prevent movement of the power tool independent of the mounting assembly, and in certain embodiments, further providing stabilization of the power tool in all directions. It is appreciated that fastening, where used, may be accomplished by use of an adjustable strap, clamp, fixed or adjustable bracket, quick connect and release, a vice or combinations thereof. Fasteners may be composed of woven fibers, polymers, carbon fibers, steel, aluminum, combinations thereof or other materials. In some embodiments, the fastening means is an adjustable strap, a clamp, a fixed bar or plate for the power tool to be mounted rigidly against, or combinations thereof.

### Ergonomic Frame

The tool of any of claims 1 to 7 wherein said intermediate extent further comprises of a lower portion and an upper portion, wherein said lower portion and upper portion are connected with at least one angular offset forming a bend between said upper portion and said lower portion, whereby said handle and said mounting assembly are at different angles with respect to an operating surface.

The tool of any of claims 1 to 8 wherein said intermediate extent can be telescopically operated to increase or decrease the length of the intermediate extent.

The tool of any of claims 1 to 9 wherein said handle further comprises at least one hand holding portion and at least one connection portion, said hand holding portion angularly offset from said connection portion, wherein said connection portion is perpendicularly connected to said upper portion of said intermediate extent.

The tool of claim 9 wherein said handle portion of said handle bar is angularly offset from said connection portion.

In certain embodiments, the tool has a length between four and five feet long. In one embodiment it is made from bent pipe and has an assembly for holding a power tool securely in place at the distillate end while controlling the tool from handlebars situated at the proximate end.

In the present embodiment Ergonomic Frame is approximately 5 feet in length, comprising of a lower portion and an upper portion. In other embodiments is may be as short as 3 feet in length, as long as 6 feet in length or any other length necessary to accomplish its function. The lower portion is connected to the mounting assembly described more fully in paragraphs 19 and 20. The upper portion connects to the Ergonomic Handle and Control Mechanism described in paragraph 24. The Ergonomic Frame aligns the lower portion to the upper portion with at least one angular offset. Said offset allows the operator to grasp the handles in an ergonomic position while maintaining an optimal angle of incidence between the hand-held power tool and the material or surface being operated on. The angle may be fixed or adjustable. The offset may be accomplished by one or multiple bends or a sinusoidal curve or any combination thereof.

The Ergonomic Frame may consist of steel, aluminum, carbon fiber, polymer, a combination thereof, or other materials. It may be constructed from pipe, flat or angled stock, extrusion, honey combed or any combination thereof. It may be fixed in length or telescoping.

The length of the Ergonomic Frame and the offset between the hand-held power tool and the Ergonomic Handle and Control Mechanism described in paragraphs 24 allow the operator to use the invention while maintaining an ergonomic position at all times.

### Ergonomic Handle and Control Mechanism

Some embodiment of the present invention, the handle bar further comprises one or more non-conductive triggers electrically or mechanically connected to the power tool attached to the attachment mechanism to allow the operator to start and stop the hand-held power tool from the handle bars. It is intended that such allows the operator to control the hand-held power tool from an upright and ergonomic stance.

In at least one embodiment the ergonomic handle and control mechanism consists of at least one portion that connects it to the ergonomic frame and at least one hand holding portion angularly offset to said frame. While it is appreciated that embodiments of this feature may be constructed from any material known in the art, certain advantages may be realized if embodiments are constructed from materials selected from steel, aluminum, carbon fiber, polymer, a combination thereof, or other materials. Furthermore, embodiments may be constructed from pipe, flat or angled stock, extrusion, honey combed or any combination thereof.

Some embodiments of the present invention, the handle may be fixed in position or adjustable. In such embodiments the mechanism further comprises one or more non-conductive triggers electrically or mechanically connected to the power tool attached to the attachment mechanism. Where used, said triggers allow the operator to start and stop the hand-held power tool from the handle bars.

Dust collection mechanism

It is appreciated that one unmet need to be addressed is the control of dust and debris during using demolition tools which may be incorporated with the present invention. In at least one embodiment, the inventive tool further includes a dust collection mechanism attached at or about the mounting assembly for enabling the collection of dust at the power tools point of use. In at least one embodiment, the dust collection mechanism has two ends, a first end and a second end, said first end proximate to the distal end of the tool, and said second end proximate to the intermediate extent, wherein said first end and said second end are connected forming a hollow tube. In certain embodiments, the dust collection mechanism further includes a connection means for a vacuum hose.

It is intended that, when used, the dust collection mechanism enables the collection of dust and particles at the point of use of the hand-held power tool while mounted in the invention. In at least one embodiment the dust collection mechanism attaches at or about the mounting assembly. In another embodiment it may attach directly to said power tool.

It is appreciated that a shop vac hose may be attached to the upper end of the dust collection mechanism to assist in the extraction of dust and particles caused by cutting, chipping, drilling, planing, demolishing or various other tasks on a material or structure. In one embodiment the shop vac hose is secured to the mechanism with connectors. In another embodiment the hose is press-fit into the mechanism.

Certain embodiments include that the bottom of the dust collection mechanism contains a non-clogging vacuum head attachment. In at least one embodiment the non-clogging dust collection mechanism is a wire mesh that prevents large particles from being drawn into the said dust collection mechanism. Where used, the dust collection mechanism may be comprised of metals, polymers, or other materials. In other embodiments, the dust collection mechanism may be fixed in position or it may be adjustable.

### Rolling Apparatus and Other Comfort Features

To assist with the comfort of the user, other features may be incorporated. In at least one embodiment, the lower frame assembly further comprises at least one rolling apparatus. Where used, the rolling apparatus is a wheel, a bearing, a series of wheels or bearings, a ball, a track ball, a castor, or combinations or equivalents thereof

Another feature which is incorporated in certain embodiments is to include at least one step pad with the lower portion of the intermediate extent allowing the operator to use his legs and body weight to forcibly propel the hand-held power tool into the surface being operated on.

In some embodiments, the lower frame assembly further includes a foot-stand (or kick stand) that supports the unit in the upright position and prevents it from toppling over when not in use. In at least one embodiment the foot-stand of made of aluminum and can be retracted. In another embodiment it may be made out of another material, or fixed or a combination thereof.

It is appreciated that with certain embodiments, the frame assembly may also include a mechanism for mounting additional weight to the unit for aid in exerting additional force onto the mounted hand-held power tool.

### Dust Control Sensor

It is appreciated that dust limitations may need to be measured for the health, safety, and/or comfort of the workers or bystanders. In fact, in some cases local, state, provincial, or federal governments may have regulations for permissible limits of dust. In many cases if measuring dust, by the time a dust measuring device measures dust that reaches or exceeds permissible dust levels, the levels will actually be far in excess since the fresh dust from the tools have yet to dissipate. Thus certain embodiments of the ergonomic dust extraction extender tool include one or more dust sensors to allow for the detection and measurement dust content and amounts at the source of the dust, thus allowing for maintaining levels in a work environment within limits. Without intending to limit the invention, OSHA requires that crystalline silica dust be maintained below 25 ug/m³. Thus embodiments may include a dust sensor that allows for the determination of crystalline silica content within the dust, and optionally includes a display or alarm which alerts the user of the ergonomic dust extraction extender tool when crystalline silica approaches that level. It is appreciated that use of such sensors with the ergonomic dust extraction extender tool may be placed at any location on the tool. In at least one embodiment the sensor and optional display is placed on the handle bar such that a user of the ergonomic dust extraction extender tool may view the levels as reported in real-time from the sensor. In other embodiments, the sensor is place at or near the tool mounting assembly or the intermediate extent. In some embodiments where the sensor is placed at or near the tool mounting assembly or the intermediate extent, the optional display may be placed on the handle bar for user monitoring.

### EXAMPLES

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

### Example 1

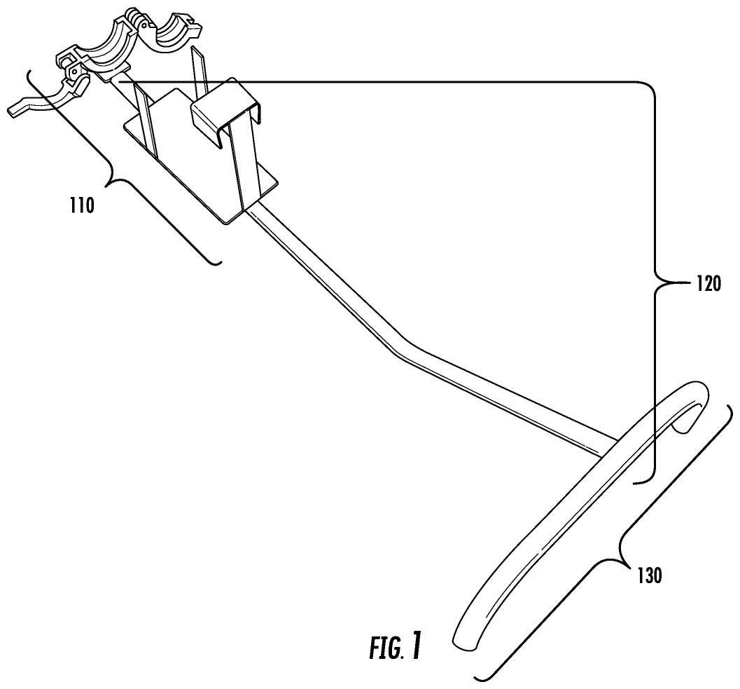

The drawings and diagrams shown herein depict example arrangements of elements of the apparatus and method. More or less than all the features available or contemplated may be present in an actual embodiment. It should also be understood that FIGS. 1-7 are merely illustrative and may not be drawn to scale.

FIGS. 1-3 illustrate at least one embodiment of 100 an ergonomic, dust extraction extender tool for attachment and use with power tools. The 100 tool includes 110 the hand-held power tool mounting assembly, 120 the ergonomic frame and 130 the ergonomic handle and control mechanism. In at least one embodiment the 100 tool includes a 111 backing to secure the handle of the hand-held power tool to the extender shaft, 112 a fastening means for securing the handle of the hand-held power tool, 113 a series of fastening means for securing the body of the hand-held power tool and, 114 a fastening means for securing the nose of the hand-held power tool.

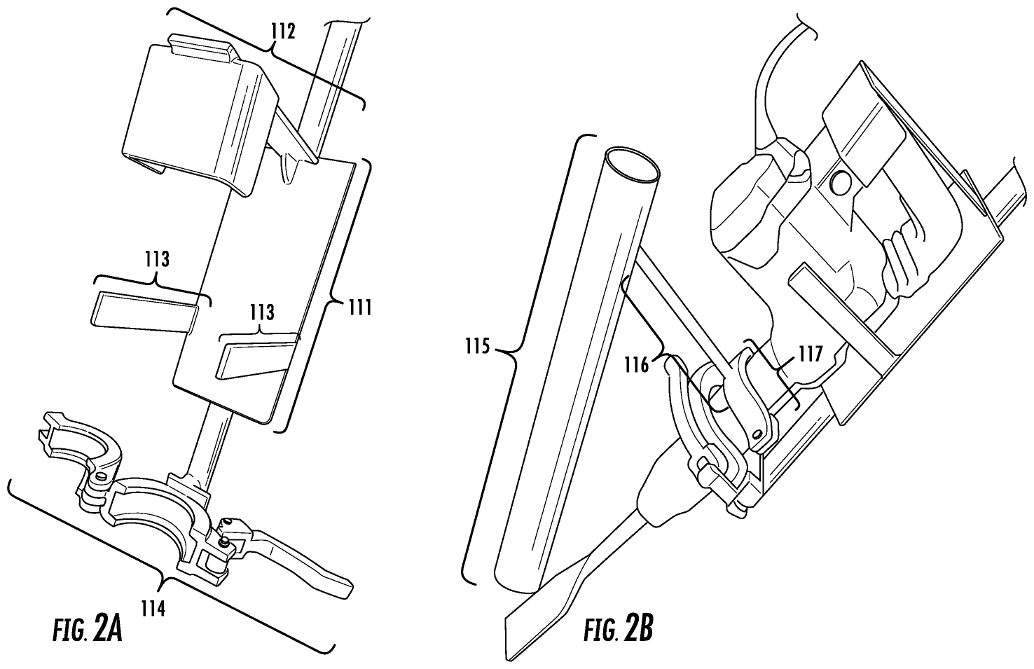

FIG. 2B illustrates one embodiment of the dust collection mechanism. The dust collection mechanism consists of 115 a mechanism for positioning and securing a vacuum hose, 117 a mechanism for securing the dust collection mechanism, and 116 a positioning mechanism that connects 115 the flexible vacuum hose positioning mechanism to 117 the securing mechanism. In another embodiment 116 the positioning mechanism may pivot allowing operators to manually adjust the angle of incidence.

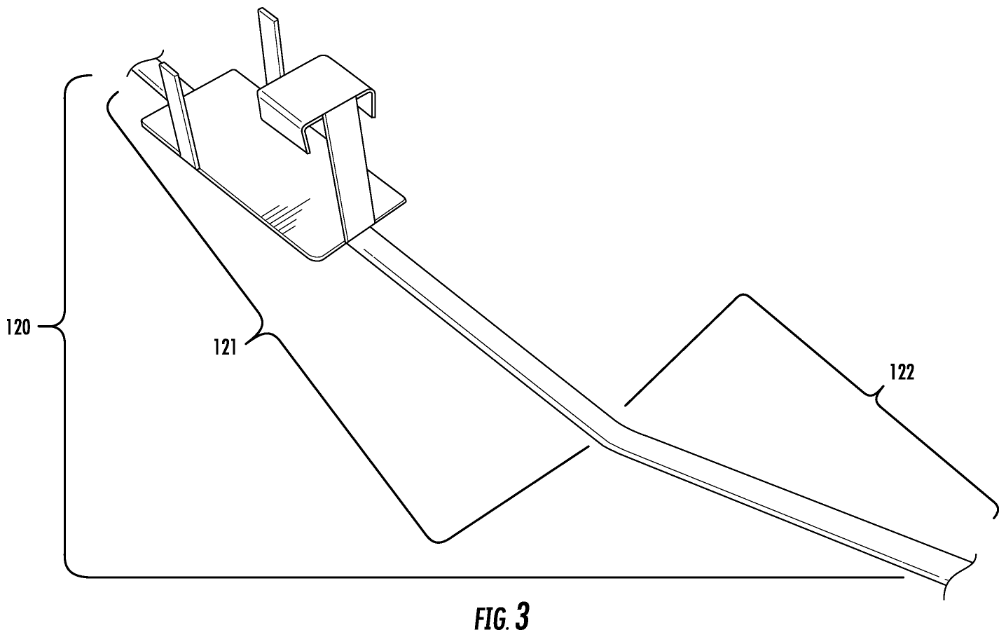

FIG. 3 illustrates at least one embodiment of 100 an ergonomic, dust extraction extender tool for attachment and use with power tools. The 100 ergonomic, dust extraction extender tool for attachment and use with power tools includes 120 the ergonomic frame, the 121 lower frame, the 122 upper frame assembly. Offsetting the 121 lower frame assembly and the 122 upper frame assembly allows operators to stand in an upright or prone position during operation, reducing the strain on their musculoskeletal systems. In the present embodiment the offset is accomplished with one fixed bend in the 120 ergonomic frame. In another embodiment the upper and lower shaft may be offset by multiple fixed bends or a sinusoidal curve. In another embodiment the offset or offsets may be adjustable. In still another embodiment of the 121 lower frame assembly, the shaft may be telescoping allowing operators to increase or decrease the length of the shaft.

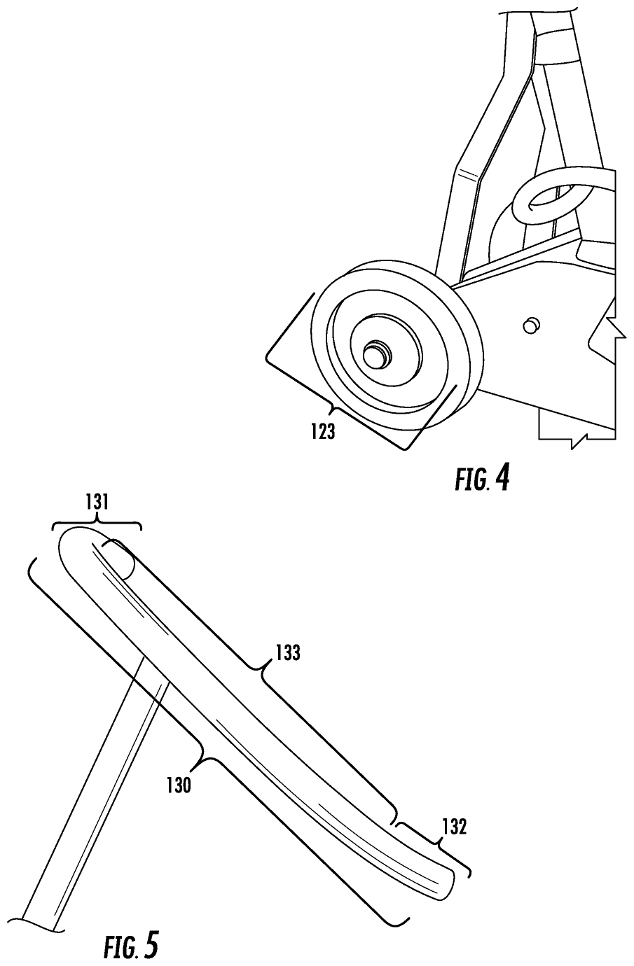

FIG. 4 illustrates at least one embodiment of the 121 lower frame assembly which may also include 123 a rolling apparatus attached to the back that bears the weight of the unit, aid in transport or positioning of the unit, and allows it to stand upright when not in use. The 123 rolling apparatus may include wheels comprised of solid rubber, a hard rubber tire surrounding an inflatable tube, steel, aluminum, soft metals, polymers or any other material. In another embodiment rolling apparatus may include a bearing, a series of wheels or bearings, a ball, a track ball, a castor, or combinations or equivalents thereof

FIG. 5 provides an overhead view of one embodiment of the 130 the ergonomic handle bar mechanism, illustrating the ergonomic offset of the 131 right hand grip and the 132 left hand grip from the 133 main handlebar shaft. In another embodiment the handle bar mechanism may be curved or shaped with little to no offset off the hand grips. In another embodiment the hand grips may be adjustable along the horizontal plane, the vertical plane or both planes. In still another embodiment the mechanism may be adjustable at the point of connection to the 120 ergonomic frame.

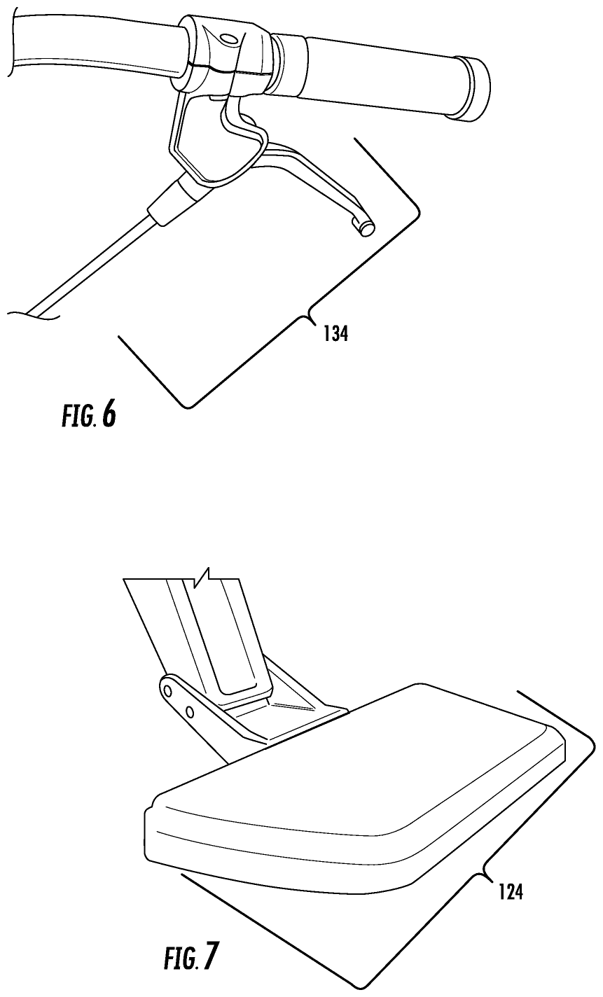

FIG. 6 illustrates at least one embodiment of the handle bar mechanism which may include 134 non-conductive triggers on the hand grips that allow operators to start and stop the hand-held power tool from the handle bars.

FIG. 7 illustrates another embodiment of the 121 lower frame assembly which may include 124 a step pad allowing operators to use their legs and body weight to forcibly propel the hand-held power tool into the surface being operated on.

### Other Embodiments

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the described embodiments in any way. Rather, the foregoing detailed description will provide those skilled in the art with a convenient road map for implementing the exemplary embodiment or exemplary embodiments. It should be understood that various changes can be made in the function and arrangement of elements without departing from the scope as set forth in the appended claims and the legal equivalents thereof.

1. An ergonomic dust extraction extender tool having two ends, a proximate end and a distal end, for use with the operation of power tools, the tool comprising:
a tool mounting assembly at the distal end of said tool;
a handle at the proximate end of said tool; and
an intermediate extent connected between said mounting assembly and said handle.

2. The tool of claim 1 wherein said tool mounting assembly contains at least one fastening means to secure a hand-held power tool to the mounting assembly.

3. The tool of claim 2 wherein said one or more fastening means prevents movement of the power tool independent of the mounting assembly, wherein said fastening means provides stabilization of the power tool in all directions.

4. The tool of claim 2 wherein said fastening means is an adjustable strap, a clamp, a fixed bar or plate for the power tool to be mounted rigidly against, or combinations thereof.

5. The tool of claim 1further comprising a dust collection mechanism attached at or about said mounting assembly for enabling the collection of dust at said power tools point of use.

6. The tool of claim 5 wherein said dust collection mechanism has two ends, a first end and a second end, said first end proximate to the distal end of the tool, and said second end proximate to the intermediate extent, wherein said first end and said second end are connected forming a hollow tube.

7. The tool of claim 6 wherein said dust collection mechanism includes a connection means for a vacuum hose.

8. The tool of claim 1 wherein said intermediate extent further comprises of a lower portion and an upper portion, wherein said lower portion and upper portion are connected with at least one angular offset forming a bend between said upper portion and said lower portion, whereby said handle and said mounting assembly are at different angles with respect to an operating surface.

9. The tool of claim 1 wherein said intermediate extent can be telescopically operated to increase or decrease the length of the intermediate extent.

10. The tool of claim 1 wherein said handle further comprises at least one hand holding portion and at least one connection portion, said hand holding portion angularly offset from said connection portion, wherein said connection portion is perpendicularly connected to said upper portion of said intermediate extent.

11. The tool of claim 9 wherein said handle portion of said handle bar is angularly offset from said connection portion.

12. The tool of claim 1 wherein said lower frame assembly further comprises at least one rolling apparatus, wherein said rolling apparatus is a wheel, a bearing, a series of wheels or bearings, a ball, a track ball, a castor, or combinations or equivalents thereof.

13. The tool of claim 1 wherein said handle bar further comprises one or more non-conductive triggers electrically or mechanically connected to the power tool attached to the attachment mechanism to allow the operator to start and stop the hand-held power tool from the handle bars.

14. The tool of claim 1 wherein said lower portion of said intermediate extent further comprises at least one step pad allowing the operator to use his legs and body weight to forcibly propel the hand-held power tool into the surface being operated on.

15. An ergonomic dust extraction extender tool having two ends, a proximate end and a distal end, for use with the operation of power tools, the tool comprising:
a tool mounting assembly at the distal end of said tool, said tool mounting assembly containing at least one fastening means to secure a hand-held power tool to the mounting assembly;
a handle at the proximate end of said tool having at least one hand holding portion and at least one connection portion, said hand holding portion angularly offset from said connection portion, wherein said connection portion is perpendicularly connected to said upper portion of said intermediate extent;
an intermediate extent connected between said mounting assembly and said handle said intermediate extent having a lower portion and an upper portion, wherein said lower portion and upper portion are connected with at least one angular offset forming a bend between said upper portion and said lower portion, whereby allowing said handle and said mounting assembly to be at different angles with respect to an operating surface; and
a dust collection mechanism attached at or about said mounting assembly for enabling the collection of dust at said power tools point of use, wherein said dust collection mechanism has two ends, a first end and a second end, said first end proximate to the distal end of the tool, and said second end proximate to the intermediate extent, wherein said first end and said second end are connected forming a hollow tube, and further having a connection means for a vacuum hose..

16. (canceled)

17. The tool of claim 15 wherein said fastening means is an adjustable strap, a clamp, a fixed bar or plate for the power tool to be mounted rigidly against, or combinations thereof.

18. The tool of claim 15 wherein said intermediate extent can be telescopically operated to increase or decrease the length of the intermediate extent.

19. The tool of claim 15 wherein said handle further comprises at least one hand holding portion and at least one connection portion, said hand holding portion angularly offset from said connection portion, wherein said connection portion is perpendicularly connected to said upper portion of said intermediate extent.

20. The tool of claim 15 wherein said handle portion of said handle bar is angularly offset from said connection portion.

21. (canceled)

22. The tool of claim 15 wherein said handle further comprises one or more non-conductive triggers electrically or mechanically connected to the power tool attached to the attachment mechanism to allow the operator to start and stop the hand-held power tool from the handle.
